(19) United States
(12) Patent Application Publication
(10) Pub. No.: US 2013/0002789 A1
(43) Pub. Date: Jan. 3, 2013

(54) LIGHT SCANNING APPARATUS AND ELECTROPHOTOGRAPHIC IMAGE FORMING APPARATUS

(75) Inventor: Hiromasa Katayama, Toride-shi (JP)

(73) Assignee: CANON KABUSHIKI KAISHA, Tokyo (JP)

(21) Appl. No.: 13/517,812

(22) Filed: Jun. 14, 2012

(30) Foreign Application Priority Data
Jun. 30, 2011 (JP) 2011-145407

(51) Int. Cl. B41J 2/435; G02B 26/10

(52) U.S. Cl. 347/224; 359/212.1

(57) ABSTRACT

A light scanning apparatus to be used in an electrophotographic image forming apparatus, the light scanning apparatus including: a housing having an outer wall provided with an opening; a light source configured to emit a light beam; a deflecting device provided in the housing and configured to deflect the light beam emitted from the light source such that the light beam emitted from the light source scans a photosensitive member; an optical element arranged on an optical path of the light beam in the housing; and an elastic member provided on the housing to block up the opening, wherein the elastic member is formed of a material which is deformable to increase and decrease a volumetric capacity of an internal space formed by the housing and the elastic member in accordance with a temperature fluctuation inside the housing.

### BACKGROUND OF THE INVENTION

1. Field of the Invention

The present invention relates to a light scanning apparatus including a heating member which generates heat and an optical element, and to an electrophotographic image forming apparatus having the light scanning apparatus.

2. Description of the Related Art

Generally, an electrophotographic image forming apparatus includes a light scanning apparatus. Examples of the electrophotographic image forming apparatus include a laser-beam printer, a facsimile, and a digital copying machine. Examples of the light scanning apparatus include a light scanning apparatus that scans a scan object with a light beam. The light scanning apparatus includes a deflecting device configured to deflect the light beam, and optical elements such as a reflecting mirror and a transmitting lens.

When wafting particles or dusts adhere to a surface of such an optical element, the adhered particles or dusts block a portion of a reflected light beam or a transmitted light beam, generating a streaky density change portion on an image.

The deflecting device disposed in the light scanning apparatus includes a rotary polygon mirror. When the amount of the adhered particles or dusts varies for each deflecting surface of the rotary polygon mirror, each scanning line may show a different density, generating an image defect called an “uneven pitch.”

Therefore, an effort is being put into enhancing the airtightness of a housing of the light scanning apparatus to prevent the optical elements from getting dirty by the wafting particles or dusts entering from outside the housing. However, considering assembly and maintenance of the apparatus, it is hard to achieve a perfect airtight structure for the light scanning apparatus. Normally, the housing comprises an optical box and an upper cover. The airtightness of the housing is enhanced by arranging a sealing member such as a rubber foam sheet between the optical box and the upper cover.

However, when the rotary polygon mirror in the light scanning apparatus is rotated at high speed, a density variation (lean and dense) is generated in the air inside the light scanning apparatus, thus changing the pressure inside the light scanning apparatus. The change in pressure may generate a gap between the optical box and the upper cover.

In order to prevent the gap from occurring between the optical box and the upper cover, a technique of providing an elastic member on a portion of the optical box has been proposed, such that the elastic member absorbs the change in pressure inside the light scanning apparatus (Japanese Patent Application Laid-Open No. 2000-89152). However, even if the gap caused by the change in pressure does not occur, there may be a flow of the air in and out of the light scanning apparatus through between the optical box and the upper cover. The reason is, although the sealing member is sandwiched between the optical box and the upper cover, it is hard to seal perfectly the whole contact area between the optical box and the upper cover.

FIGS. 8A and 8B are views illustrating a rubber foam seal 92 arranged between an optical box 90 and an upper cover 91 of a light scanning apparatus 6.

As illustrated in FIG. 8A, there may be a slight gap between the upper cover 91 and the rubber foam seal 92. Further, as illustrated in FIG. 8B, there may be a slight gap between the optical box 90 and the rubber foam seal 92.

When the light scanning apparatus 6 is operated and a rotary polygon mirror (heating member) is rotated continuously, the temperature of the air inside the light scanning apparatus 6 increases and the air expands. The expanded air is leaked little by little through the slight gap to outside the light scanning apparatus 6. The temperature of the air inside the light scanning apparatus 6 is increased, for example, by about 10° C. for about two hours.

As the temperature of the internal air is gradually increased over time, the air is leaked little by little without generating a large pressure difference between inside and outside the light scanning apparatus 6.

When the operating of the light scanning apparatus 6 is stopped, the temperature of the air inside the light scanning apparatus 6 decreases and the air contracts. When the air inside the light scanning apparatus 6 contracts, the air outside the light scanning apparatus 6 flows into the light scanning apparatus 6 little by little through the slight gap between the optical box 90 and the upper cover 91.

As the temperature of the internal air is gradually decreased over time to return to an ambient temperature, the air inflows little by little without generating a large pressure difference between inside and outside the light scanning apparatus 6.

When a large pressure difference occurs between inside and outside the light scanning apparatus 6, the pressure difference can be absorbed by the elastic member proposed in Japanese Patent Application Laid-Open No. 2000-89152. However, the phenomenon of the air being leaked little by little or inflowing little by little does not generate a force sufficient to deform the elastic member, and hence this type of phenomenon cannot be prevented by the elastic member.

Due to the repeated operating and stopping of the light scanning apparatus 6, expansion and contraction of the air is repeated according to the increase and decrease of the temperature of the air inside the light scanning apparatus 6. This causes the air to flow in and out of the light scanning apparatus 6 through the slight gap between the optical box 90 and the upper cover 91 of the light scanning apparatus 6 so that the wafting particles or dusts are inhaled into the light scanning apparatus 6. The inhaled wafting particles or dusts adhere onto the optical elements in the light scanning apparatus 6, thus causing an image defect.

In particular, in a region where concentrations of sulfur dioxide and ammonium in the air are high, the sulfur dioxide and the ammonium react chemically with each other to produce ammonium sulfate, and this ammonium sulfate may adhere to the optical elements as white powder, thus causing an image defect.

### SUMMARY OF THE INVENTION

The present invention provides a light scanning apparatus which can prevent air from flowing in and out through between at least two components which constitute a housing, even when the air inside the housing expands and contracts.

According to an exemplary embodiment of the present invention, there is provided a light scanning apparatus to be used in an electrophotographic image forming apparatus, the light scanning apparatus including: a housing having an outer wall provided with an opening; a light source configured to emit a light beam; a deflecting device provided in the housing and configured to deflect the light beam emitted from the light source such that the light beam emitted from the light source scans a photosensitive member; an optical element arranged on an optical path of the light beam in the housing; and an elastic member provided on the housing to block up the opening, wherein the elastic member is formed of a material which is deformable to increase and decrease a volumetric capacity of an internal space formed by the housing and the elastic member in accordance with a temperature fluctuation inside the housing.

Further features of the present invention will become apparent from the following description of exemplary embodiments with reference to the attached drawings.

### BRIEF DESCRIPTION OF THE DRAWINGS

FIG. 1 is a cross-sectional view of an image forming apparatus according to a first embodiment.

FIGS. 2A, 2B, and 2C are perspective views of a light scanning apparatus according to the first embodiment.

FIG. 3 is a vertical cross-sectional view of the light scanning apparatus according to the first embodiment.

FIGS. 4A and 4B are cross-sectional views of a swelling and deflating member according to the first embodiment.

FIG. 5 is a perspective view of a cover with a louver.

FIGS. 6A, 6B, and 6C are perspective views of an opening and a swelling and deflating member of a light scanning apparatus according to a second embodiment.

FIG. 7 is a perspective view illustrating a method of achieving airtightness by using a tape.

FIGS. 8A and 8B are views illustrating a rubber foam seal between an optical box and an upper cover of a light scanning apparatus.

### DESCRIPTION OF THE EMBODIMENTS

Embodiments of the present invention will be described below with reference to the accompanying drawings.

### First Embodiment

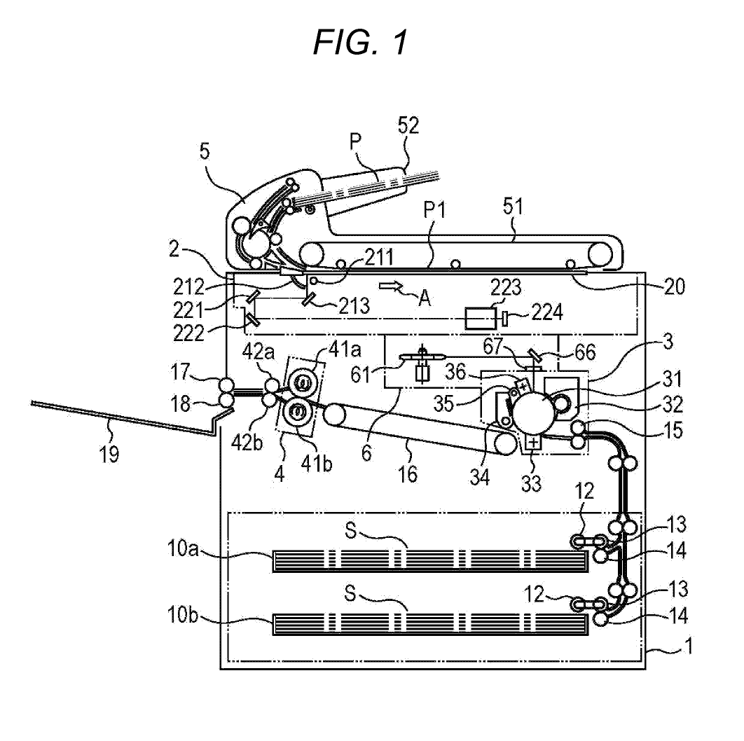

FIG. 1 is a cross-sectional view of an electrophotographic image forming apparatus 1 according to a first embodiment of the present invention. A digital copying machine will be described as an example of the image forming apparatus 1.

An automatic document feeding device 5 is provided on an upper portion of the image forming apparatus 1. The automatic document feeding device 5 feeds a document (original) P placed on a document tray 52 to an original glass plate 20. A document P1 on the original glass plate 20 is conveyed by a document conveying belt 51.

An image reading device (optical unit) 2 is provided below the original glass plate 20. The image reading device 2 includes a light source 211, a reflecting plate 212, reflecting mirrors 213, 221, and 222, an imaging lens 223, and an image sensor 224. The light source 211, the reflecting plate 212, and the reflecting mirrors 213, 221, and 222 are moved in a direction indicated by an arrow A. Light from the light source 211 illuminates the document P1 placed on the original glass plate 20 via the reflecting plate 212. A reflected light from the document P1 is imaged on the image sensor 224 via the reflecting mirrors 213, 221, and 222 and the imaging lens 223. The image sensor 224 reads an image of the document P1.

The image sensor 224 converts read image information into an image signal. The image signal is received by a digital processing portion (not shown) and converted into digital data. The digital data is subjected to necessary data processing and output to a video converting portion (not shown) as image data. The video converting portion converts the image data into a video signal. The video signal is transmitted to a light scanning apparatus 6.

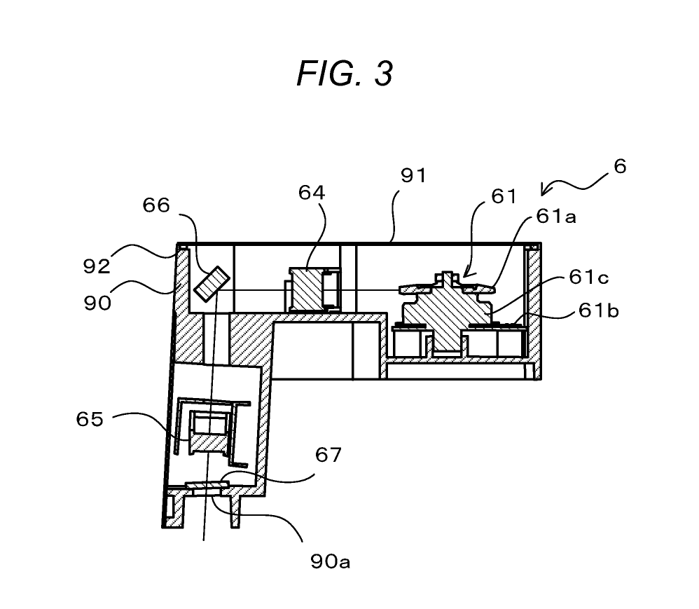

The light scanning apparatus 6 includes a deflecting device (deflecting unit) 61, a light source device 62 (FIG. 3), and multiple optical elements disposed on an optical path. The light scanning apparatus 6 scans a light beam (laser beam) modulated based on the video signal from the video converting portion onto a photosensitive drum (photosensitive member) 31 as a member (scan object) to be scanned by the light beam.

An image forming portion 3 includes the photosensitive drum 31, and a pre-exposing device 35, a charging device 36, a developing device 32, a transfer charging unit 33, and a cleaning device 34 disposed around the photosensitive drum 31. The entire surface of the photosensitive drum 31 is irradiated with light by the pre-exposing device 35 and uniformly charged by the charging device 36. The light scanning apparatus 6 irradiates the uniformly charged surface of the photosensitive drum 31 with the modulated light beam, to thereby form a latent image on the surface of the photosensitive drum 31. The latent image is developed into a toner image by the developing device 32.

Meanwhile, a recording medium S in a sheet feeding cassette 10a or 10b is picked up one by one by a pickup roller 12 and fed to a registration roller 15 by feeding rollers 13 and 14. The registration roller 15 conveys the recording medium S to the transfer charging unit 33 in timed relation to the toner image on the photosensitive drum 31. The transfer charging unit 33 transfers the toner image on the photosensitive drum 31 onto the recording medium S. The recording medium S is conveyed to a fixing unit 4 by a conveying portion 16. The fixing unit 4 heats and pressurizes the recording medium S with a pair of rollers 41a and 41b, to thereby fix the toner image to the recording medium S. The recording medium S having the toner image fixed thereto is then delivered onto a delivery tray 19 by a pair of rollers 42a and 42b and a pair of delivery rollers 17 and 18.

Residual toner left on the photosensitive drum 31 is removed by the cleaning device 34.

The light scanning apparatus 6 according to the first embodiment will be described below.

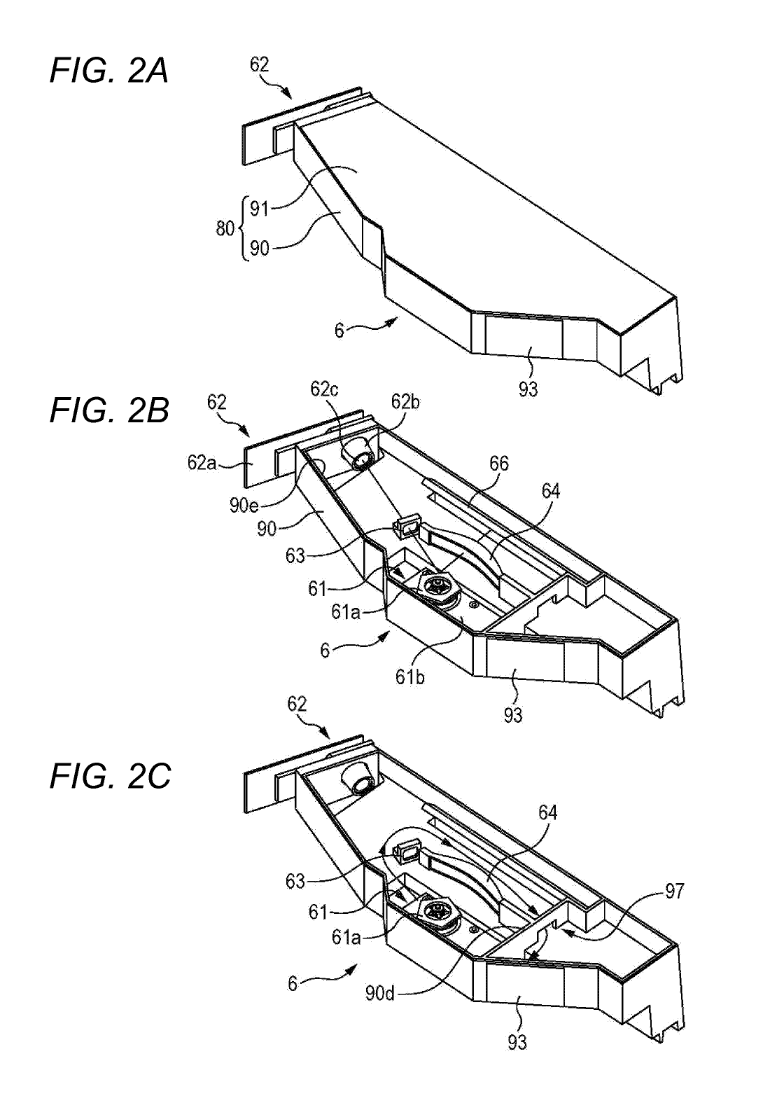

FIGS. 2A, 2B, and 2C are perspective views of the light scanning apparatus 6. FIG. 2A is a perspective view of the light scanning apparatus 6 on which an upper cover 91 is mounted. FIG. 2B is a perspective view of the light scanning apparatus 6 from which the upper cover 91 is removed. FIG. 2C is a perspective view illustrating a positional relation between a rotary polygon mirror 61a and a swelling and deflating member 93 of the light scanning apparatus 6. FIG. 3 is a vertical cross-sectional view of the light scanning apparatus 6 according to the first embodiment.

The light scanning apparatus 6 includes a housing formed of at least two components 90 and 91. The at least two components include an optical box (housing member) 90 and the upper cover (cover member) 91. After the optical elements are accommodated in the optical box 90 of the housing 80, an opening 90e in an upper portion of the optical box 90 is covered by the upper cover 91. A rubber foam sheet (sealing member) 92 (FIG. 3) is sandwiched between the optical box 90 and the upper cover 91, to thereby enhance the airtightness of the housing 80.

A cylindrical lens 63, a toric lens 64, a reflecting mirror 66, and a toric lens 65 serving as the optical elements are disposed on the optical path in the housing 80.

The light source device 62 provided in the light scanning apparatus 6 includes a semiconductor laser (not shown), an electrical driving substrate 62a configured to drive the semiconductor laser, a collimator lens barrel 62b, a collimator lens 62c, and an aperture-stop (not shown). The light source device 62 emits collimated laser light (hereinafter referred to as a “light beam”).

The cylindrical lens 63 converts the collimated light beam emitted from the light source device 62 into line-shaped light converged in a sub-scanning direction.

The deflecting device (heating member) 61 deflects and scans the light beam. The deflecting device includes the rotary polygon mirror 61a, a driving substrate 61b, and a motor 61c. The motor 61c is mounted on the driving substrate 61b. A driving circuit configured to drive the motor 61c is mounted on the driving substrate 61b. The motor 61c rotates the rotary polygon mirror 61a.

When the deflecting device 61 is driven, the deflecting device 61 generates heat little by little. When the deflecting device 61 is driven continuously, the temperature of the air inside the housing 80 increases and the air inside the housing 80 expands. When the deflecting device 61 is stopped, the temperature of the air inside the housing 80 decreases and the air inside the housing 80 contracts.

The light beam emitted from the cylindrical lens is deflected and scanned by a rotation of the rotary polygon mirror 61a. The light beam is imaged with a predetermined spot size on the photosensitive drum 31 through the toric lens 64, the reflecting mirror 66, and the toric lens 65. The toric lens 64, the reflecting mirror 66, and the toric lens 65 are disposed on the optical path and respectively fixed to the optical box 90 by positioning and fixing units (not shown).

An opening portion 90a is formed in a bottom surface of the optical box 90. On an inner side of the optical box 90, a dustproof glass 67 is disposed to block up the opening portion 90a. The dustproof glass 67 and the optical box 90 are fixed to each other by an adhesive in a state in which considerably high airtightness is achieved without a gap. The light beam is applied on the photosensitive drum 31 through the dustproof glass 67 and the opening portion 90a.

The swelling and deflating member (soft member, an elastic member in the first embodiment) 93 which is deformable is provided on a side surface of the optical box 90. The swelling and deflating member 93 is made of a flexible material so that the swelling and deflating member is deformed to increase and decrease the volumetric capacity of the internal space of the housing 80. The flexible material is, for example, a soft material such as a polyethylene sheet having a thickness of about 30 μm.

The volumetric capacity of the housing 80 is a sum of a volumetric capacity enclosed by the optical box 90 and the upper cover 91 and a volumetric capacity enclosed by the swelling and deflating member 93. The volumetric capacity enclosed by the swelling and deflating member 93 can be increased and decreased by the deformation of the swelling and deflating member 93.

In order to prevent the air from flowing in and out of the housing 80 through between the optical box 90 and the upper cover 91 due to expansion and contraction of the air inside the housing 80 depending on the temperature fluctuation inside the housing 80 caused by a change in the amount of heat generation by the deflecting device 61, the swelling and deflating member 93 is deformable. The swelling and deflating member 93 is formed of the flexible material which is deformable to increase and decrease the volumetric capacity of the housing 80 in accordance with the expansion and contraction of the air.

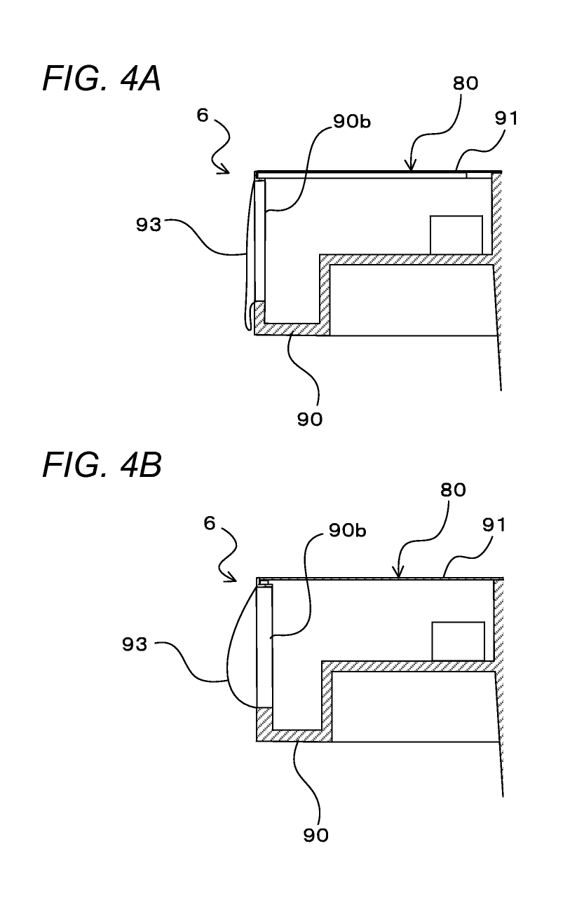

FIGS. 4A and 4B are cross-sectional views of the swelling and deflating member 93 according to the first embodiment. The swelling and deflating member 93 is provided on the housing 80 in a sagging state. The swelling and deflating member 93 is bonded to the optical box 90 by an adhesive in a state in which the high airtightness is achieved so as to block up an opening portion 90b provided in the side surface of the optical box 90.

When the light scanning apparatus 6 is in a steady state without being operated, i.e., the internal temperature of the light scanning apparatus 6 is the same as the ambient temperature, the swelling and deflating member 93 is in a sagging state as illustrated in FIG. 4A.

When the light scanning apparatus 6 is operated continuously, the deflecting device 61 generates heat by a rotation of the motor 61c, and as a result, the temperature of the air inside the light scanning apparatus 6 is increased. When the ambient temperature of the light scanning apparatus 6 is 30° C., the temperature of the air inside the light scanning apparatus 6 ends up increasing to about 40° C. in about 2 hours, maintaining a thermal equilibrium state later on.

Assuming that the volumetric capacity V inside the light scanning apparatus 6 is 500 cm³ when the swelling and deflating member 93 is in the sagging state and that the temperature T of the air inside the light scanning apparatus 6 before operating the light scanning apparatus 6 is 30° C. When a temperature T1 of the air inside the light scanning apparatus 6 after continuously operating the light scanning apparatus 6 becomes 40° C., a volume V1 of the air inside the light scanning apparatus 6 is obtained as follows based on the Charles's law (V/T=V1/T1).

500×(273+40)/(273+30)=516.5 cm³

The amount of increase of the volume of the air inside the light scanning apparatus 6 is then obtained as follows.

516.5−500=16.5 cm³

The swelling and deflating member 93 has a rectangular shape with a longitudinal length of 55 mm and a lateral length of 30 mm, and its average height can be swollen by about 10 mm. When the swelling and deflating member 93 is swollen, the volumetric capacity enclosed by the swelling and deflating member 93 is obtained as follows.

55 mm×30 mm×10 mm=16.5 cm³

That is, when the swelling and deflating member 93 is swollen, the volumetric capacity of the housing 80 of the light scanning apparatus 6 can be increased by 16.5 cm³.

When the temperature of the air inside the light scanning apparatus 6 increases and the volume of the air expands, the swelling and deflating member 93 gradually becomes in a swollen state as illustrated in FIG. 4B from the sagging state as illustrated in FIG. 4A. When the air inside the housing 80 expands in accordance with the temperature increase inside the housing 80 due to a change in the heat generation amount of the deflecting device 61, the swelling and deflating member 93 becomes swollen to increase the volumetric capacity of the housing 80.

When the state of the light scanning apparatus 6 is changed from an operating state to a stopped state, the swelling and deflating member 93 is deformed from the swollen state as illustrated in FIG. 4B to the sagging state as illustrated in FIG. 4A in accordance with a decrease in the temperature of the internal air. When the air inside the housing 80 contracts in accordance with the temperature decrease inside the housing 80 due to a change in the heat generation amount of the deflecting device 61, the swelling and deflating member 93 becomes sagged to decrease the volumetric capacity of the housing 80.

The swelling and deflating member 93 is swollen and deflated by the amount of increase and decrease in the volume of the internal air due to the thermal expansion and the thermal contraction. Therefore, flowing of the air in and out of the housing 80 through a slight gap between the optical box 90 and the upper cover 91 can be prevented. Therefore, an entering of the wafting particles or the like into the housing 80 due to the temperature change of the light scanning apparatus 6 can be prevented.

Although the amount of the increase in the volume of the air caused by the anticipated temperature increase and the volume of the swelling and deflating member 93 which can be increased are set to the same value in the first embodiment, the volume of the swelling and deflating member which can be increased may be set to a value sufficiently larger than the amount of the increase in the volume of the air caused by the anticipated temperature increase.

Further, in the first embodiment, the swelling and deflating member 93 is arranged on the side surface of the light scanning apparatus 6 so that the swelling and deflating member 93 is swollen and deflated in a direction which is less affected by the gravity, i.e., a direction orthogonal to a direction in which the gravity acts. With this arrangement, an influence of the weight of the swelling and deflating member 93 itself on the swelling and deflating of the swelling and deflating member 93 can be reduced. Therefore, the swelling and deflating member 93 can be deformed in accordance with the expansion and contraction of the air inside the light scanning apparatus 6 in a state less affected by the gravity.

In addition, as illustrated in FIG. 2C, the optical box 90 includes a labyrinth structure 97 formed of the cylindrical lens 63, the toric lens 64, and a rib 90d provided on an inner side of the optical box 90. The labyrinth structure 97 is arranged between the deflecting device 61 and the swelling and deflating member 93. That is, the swelling and deflating member 93 is arranged at a position ahead of the route around the labyrinth structure 97 from the deflecting device 61. With this arrangement, an operating sound of the deflecting device 61 can be prevented from being leaked outside the housing 80.

It is preferred that the swelling and deflating member 93 be arranged on a side surface of the housing 80 opposite to the light source device 62 with respect to the deflecting device 61. With this arrangement, when arranging the rib 90d constituting the labyrinth structure in the housing 80, the rib 90d can be prevented from being disposed on the optical path of the light beam. This makes the rib 90d easy to dispose in the housing 80.

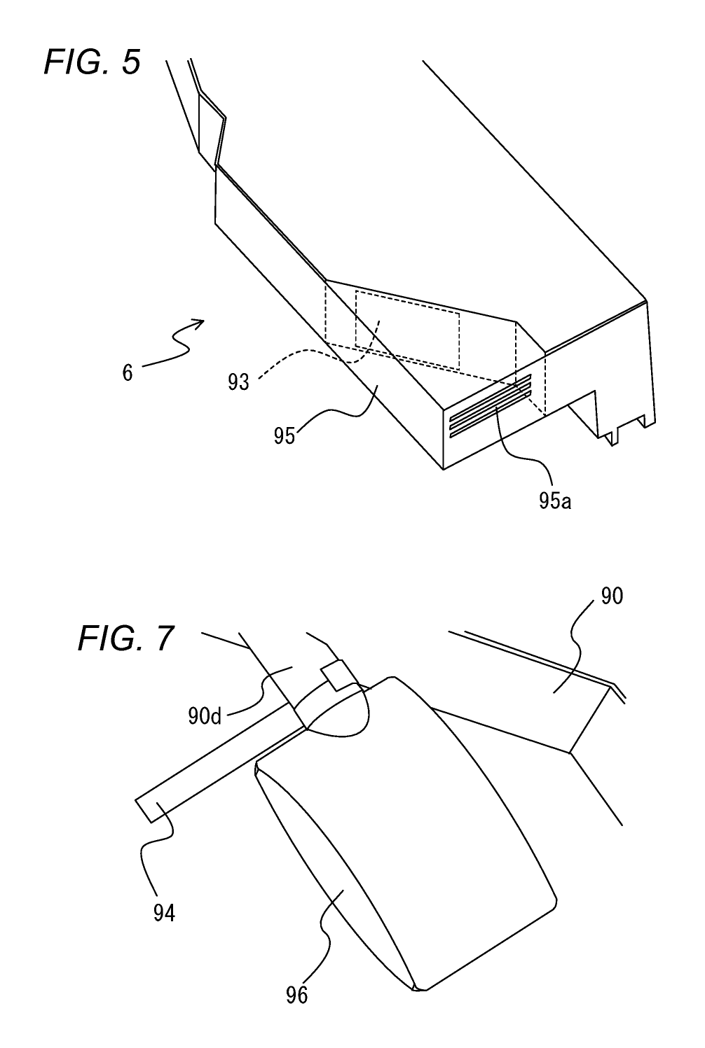

In a case in which the labyrinth structure 97 is not provided between the deflecting device 61 and the swelling and deflating member 93, a cover 95 with a louver 95a may be provided to enclose the swelling and deflating member 93 as illustrated in FIG. 5. With this arrangement, an operating sound of the deflecting device 61 can be prevented from being leaked outside the housing 80.

According to the first embodiment, even when the air inside the housing formed of at least two components expands and contracts, flowing of the air in and out of the housing through between the at least two components of the housing can be prevented.

### Second Embodiment

A light scanning apparatus 6 according to a second embodiment will be described below. In the second embodiment, a configuration similar to that of the first embodiment is assigned with the same reference symbol and a description thereof is omitted.

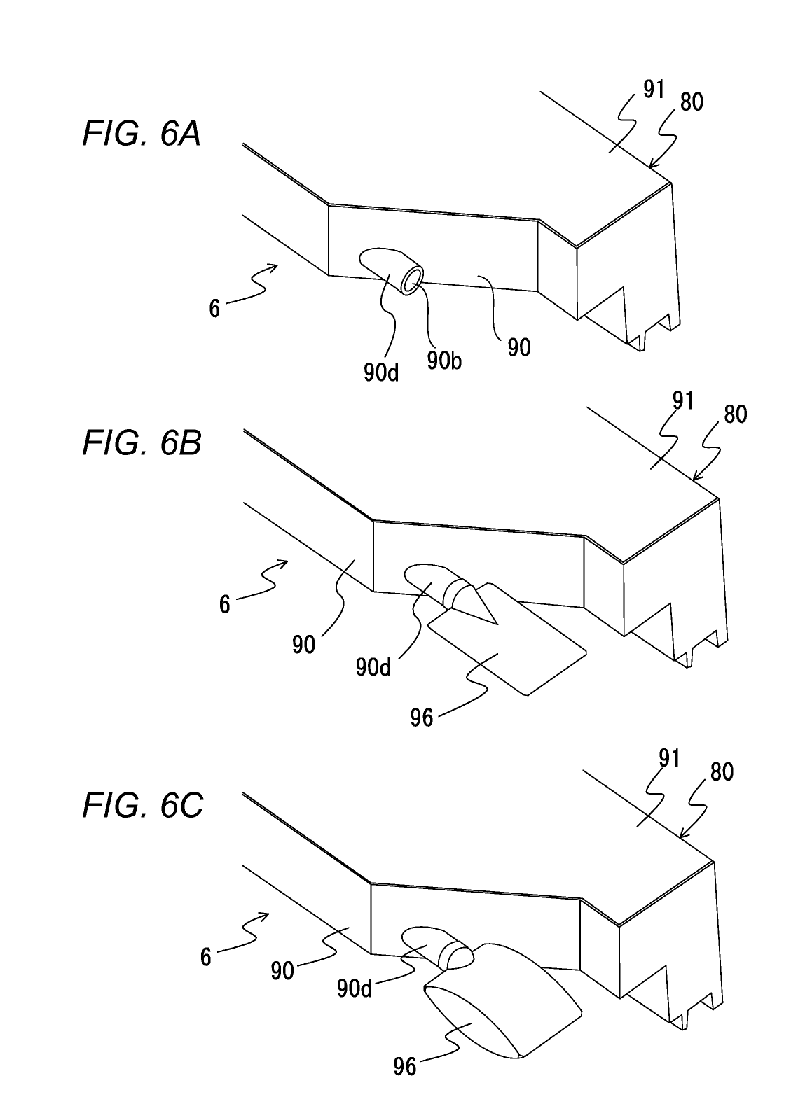

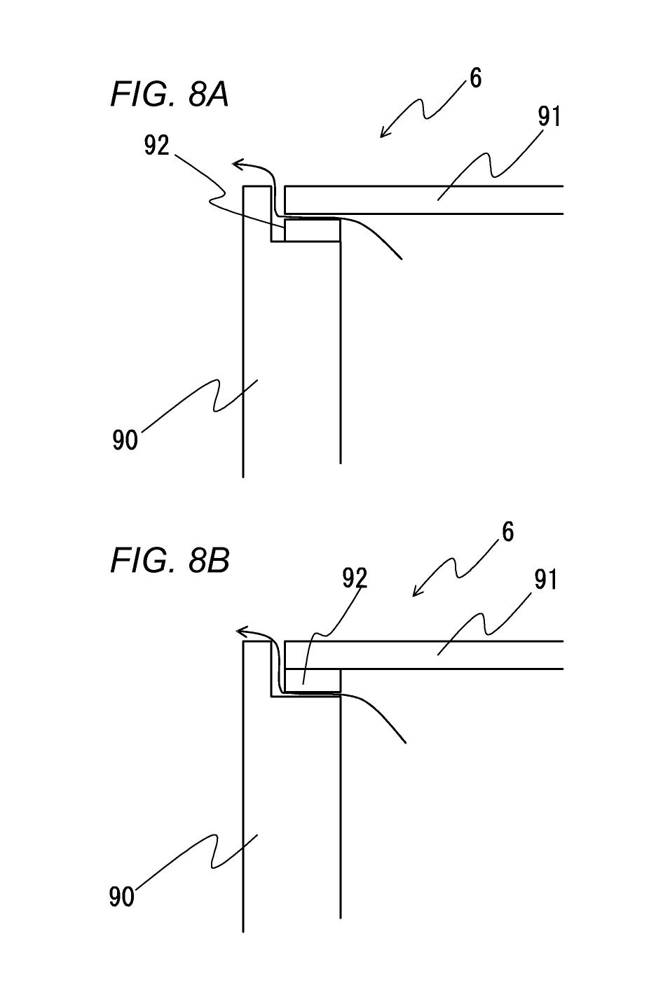

FIGS. 6A, 6B, and 6C are perspective views of an opening portion 90b and a swelling and deflating member 96 of the light scanning apparatus 6 according to the second embodiment. As illustrated in FIG. 6A, the opening portion 90b provided in an optical box 90 of the light scanning apparatus 6 according to the second embodiment is provided in a cylindrical pipe 90d. The swelling and deflating member 96 is mounted to the cylindrical pipe 90d. As illustrated in FIG. 6B, the swelling and deflating member 96 is formed into a pouch shape.

FIG. 6B illustrates a sagging state of the swelling and deflating member 96 of the pouch shape before the light scanning apparatus 6 is operated. FIG. 6C illustrates a swollen state of the swelling and deflating member 96 of the pouch shape after continuously operating the light scanning apparatus 6.

The swelling and deflating member 96 is provided on a housing 80 in the sagging state. The swelling and deflating member 96 is made of a flexible material so that that the swelling and deflating member 96 can be deformed to increase and decrease the volumetric capacity of the housing 80. In order to prevent the air from flowing in and out of the housing 80 through between the optical box 90 and an upper cover 91 due to expansion and contraction of the air inside the housing 80 depending on the temperature fluctuation inside the housing 80 caused by a change in the amount of heat generated by a deflecting device 61, the swelling and deflating member 96 is deformable. The swelling and deflating member 96 is formed of a flexible material which is deformable to increase and decrease the volumetric capacity of the housing 80 in accordance with the expansion and contraction of the air.

In the same manner as in the first embodiment, when the temperature of the air inside the light scanning apparatus 6 increases due to a continuous operating of the light scanning apparatus 6 and the volume of the air expands, the swelling and deflating member 96 gradually becomes in the swollen state as illustrated in FIG. 6C from the sagging state as illustrated in FIG. 6B. When the air inside the housing 80 expands in accordance with the temperature increase inside the housing 80 due to a change in the heat generation amount of the deflecting device 61, the swelling and deflating member 96 becomes swollen to increase the volumetric capacity of the housing 80.

When the state of the light scanning apparatus 6 is changed from an operating state to a stopped state, the swelling and deflating member 96 is deformed from the swollen state as illustrated in FIG. 6C to the sagging state as illustrated in FIG. 6B in accordance with a decrease in the temperature of the internal air. When the air inside the housing 80 contracts in accordance with the temperature decrease inside the housing 80 due to a change in the heat generation amount of the deflecting device 61, the swelling and deflating member 96 becomes sagged to decrease the volumetric capacity of the housing 80.

The swelling and deflating member 96 is swollen and deflated in accordance with an increase and decrease in the volume of the air inside the light scanning apparatus 6, flowing of the air in and out of the housing 80 through a slight gap between the optical box 90 and the upper cover 91 can be prevented. Therefore, an entering of the wafting particles or the like into the housing 80 due to the temperature change of the light scanning apparatus 6 can be prevented.

Further, in the second embodiment, the swelling and deflating member 96 is mounted to the cylindrical pipe 90d which is provided on a side surface of the light scanning apparatus 6 so that the swelling and deflating member 96 is swollen and deflated in a direction which is less affected by the gravity, i.e., a direction orthogonal to a direction in which the gravity acts. With this arrangement, an influence of the weight of the swelling and deflating member 96 itself on the swelling and deflating of the swelling and deflating member 96 can be reduced. Therefore, the swelling and deflating member 96 can be deformed in accordance with the expansion and contraction of the air inside the light scanning apparatus 6 in a state less affected by the gravity.

In addition, in the same manner as in the first embodiment, a cover with a louver may be provided to enclose the swelling and deflating member 96. With this arrangement, an operating sound of the deflecting device 61 can be prevented from being leaked outside the housing 80.

FIG. 7 is a perspective view illustrating a method of achieving airtightness by using a tape 94. As illustrated in FIG. 7, through winding of the tape 94 around a mounting portion of the swelling and deflating member 96 to the cylindrical pipe 90d, the airtightness can be easily achieved between the optical box 90 and the swelling and deflating member 96.

According to the second embodiment, even when the air inside the housing formed of at least two components expands and contracts, flowing of the air in and out of the housing through between the at least two components of the housing can be prevented.

In the above-mentioned embodiments, in the light scanning apparatus including the housing which is formed in a substantially airtight manner, when the volume of the internal air expands and contracts in accordance with an increase and decrease in the temperature of the internal air, the swelling and deflating member having a sagging is deformed to increase and decrease the volumetric capacity of the housing while maintaining the airtightness of the light scanning apparatus. As a result, an occurrence of an image defect due to a contamination of the optical elements can be prevented, without permitting a contaminated air to flow in and out of the housing through a slight gap between the optical box and the upper cover.

In the above, the light scanning apparatus 6 has been described in the embodiments. However, the present invention is not limited thereto, and is applicable to other types of optical units such as an illuminating apparatus and an image reading apparatus.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-145407, filed Jun. 30, 2011, which is hereby incorporated by reference herein in its entirety.

What is claimed is:

1. A light scanning apparatus to be used in an electrophotographic image forming apparatus, the light scanning apparatus comprising:
a housing having an outer wall provided with an opening;
a light source configured to emit a light beam;
a deflecting device provided in the housing and configured to deflect the light beam emitted from the light source such that the light beam emitted from the light source scans a photosensitive member;
an optical element arranged on an optical path of the light beam in the housing; and
an elastic member provided on the housing to block up the opening,
wherein the elastic member is formed of a material which is deformable to increase and decrease a volumetric capacity of an internal space formed by the housing and the elastic member in accordance with a temperature fluctuation inside the housing.

2. A light scanning apparatus according to claim 1, wherein the elastic member is provided on the housing in a sagging state.

3. A light scanning apparatus according to claim 1, wherein when air inside the housing expands in accordance with an increase in a temperature of the internal space of the housing due to the heat generated by the deflecting device, the elastic member becomes swollen to increase the volumetric capacity of the housing; and
wherein when the air inside the housing contracts in accordance with a decrease in the temperature of the internal space from a state in which the temperature is increased, the elastic member becomes deflated to decrease the volumetric capacity of the housing.

4. A light scanning apparatus according to claim 1, wherein the elastic member is deformed in a direction less affected by a gravity to increase and decrease the volumetric capacity of the housing.

5. A light scanning apparatus according to claim 1, wherein the elastic member is enclosed by a cover with a louver.

6. A light scanning apparatus according to claim 1, further comprising a labyrinth structure provided between the deflecting device and the elastic member.

7. A light scanning apparatus according to claim 1, wherein the elastic member is arranged on a side opposite to the light source with respect to the deflecting device.

8. An electrophotographic image forming apparatus, comprising:
a light scanning apparatus as recited in claim 1;
the photosensitive member; and
an image forming unit configured to form an image on a recording medium by developing the latent image on the photosensitive member with toner and transferring a toner image formed on the photosensitive member.
